(19) United States
(12) Patent Application Publication
(10) Pub. No.: US 2025/0242697 A1
(43) Pub. Date: Jul. 31, 2025

(54) Brake Chopper, Control Board, Bus Voltage Control Method, Device and Medium

(71) Applicant: Siemens Healthineers AG, Forchheim (DE)

(72) Inventors: Zhi Wei Sun, Shanghai (CN); Volker Model, Fürth (DE); Martin Meyndt, Uttenreuth (DE); Lei Liu, Shanghai (CN); Zhu Gao Ding, Shanghai (CN); Bing Liu, Shanghai (CN)

(73) Assignee: Siemens Healthineers AG, Forchheim (DE)

(21) Appl. No.: 19/041,045

(22) Filed: Jan. 30, 2025

(30) Foreign Application Priority Data
Jan. 30, 2024 (CN) 202410129935.3

(51) Int. Cl. B60L 7/12; B60L 15/20

(52) U.S. Cl. CPC B60L 7/12; B60L 15/20; B60L 2240/425; B60L 2240/427

(57) ABSTRACT

The disclosure is directed to a brake chopper, a control board, a bus voltage control method, a device and a medium. The brake chopper may include a resistor module, electrically connected to a DC bus to form an energy release circuit of the DC bus; a control module, for determining the difference between a voltage value of the DC bus and a preset first threshold, and generating a first switch control signal on the basis of the difference; and a switch module, for controlling the ON time of the energy release circuit on the basis of the first switch control signal. There may be a progressively increasing relationship between the ON time and the difference. The ON time of the energy release circuit may be precisely controlled based on the difference between 10 the DC bus voltage value and the first threshold, increasing the energy utilization rate of the DC bus.

### CROSS REFERENCE TO RELATED APPLICATIONS

This patent application claims priority to Chinese Patent Application No. 202410129935.3, filed Jun. 30, 2024, which is incorporated herein by reference in its entirety.

### BACKGROUND

### Technical Field

The present disclosure relates to the technical field of electronic devices, in particular a brake chopper, a control board, a bus voltage control method, a device and a medium.

### Related Art

Electric motor control is generally used in motion systems configured for single-axle motion or multi-axle motion. During electric motor stopping or braking, the back emf of the electric motor feeds back energy, causing the DC bus voltage to rise and cause overvoltage, which might result in damage to the electric motor driver. By using a brake chopper to dissipate this portion of energy as heat, the DC bus voltage can be kept stable.

The issue of how to improve the performance of a brake chopper is a technical problem which is still in need of a solution.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 shows a brake chopper according to exemplary embodiment(s) of the present disclosure.

FIG. 2 is a circuit diagram of a brake chopper according to exemplary embodiment(s) of the present disclosure.

FIG. 3 is a diagram showing the correspondence between the bus voltage and the switch control signal according to exemplary embodiment(s) of the present disclosure.

FIG. 4 shows a control board according to exemplary embodiment(s) of the present disclosure.

FIG. 5 is a flowchart of a bus voltage control method according to exemplary embodiment(s) of the present disclosure.

FIG. 6 shows an electronic device according to exemplary embodiment(s) of the present disclosure.

The exemplary embodiments of the present disclosure will be described with reference to the accompanying drawings. Elements, features and components that are identical, functionally identical and have the same effect are—insofar as is not stated otherwise—respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure. The connections shown in the figures between functional units or other elements can also be implemented as indirect connections, wherein a connection can be wireless or wired. Functional units can be implemented as hardware, software or a combination of hardware and software.

Embodiments of the present disclosure propose a brake chopper, a control board, a bus voltage control method, a device and a medium.

A brake chopper, may comprise:
a resistor module, electrically connected to a DC bus to form an energy release circuit of the DC bus;
a control module, for determining the difference between a voltage value of the DC bus and a preset first threshold, and generating a first switch control signal on the basis of the difference; and
a switch module, for controlling the ON time of the energy release circuit on the basis of the first switch control signal,
wherein there is a progressively increasing relationship between the ON time and the difference.

As can be seen, in one or more exemplary embodiments of the present disclosure, the difference between the DC bus voltage value and a preset threshold is used to precisely control the ON time of the energy release circuit, wherein there is a progressively increasing relationship between the ON time and the difference. Thus, the greater the difference (and correspondingly, the greater the DC bus voltage value), the longer the ON time, so as to ensure full release of energy; the smaller the difference (and correspondingly, the smaller the DC bus voltage value), the shorter the ON time, to prevent excessive release of energy. Thus, in embodiments of the present disclosure, the ON time can be controlled adaptively on the basis of the DC bus voltage value, increasing the energy utilization rate of the DC bus.

The brake chopper may further include: a temperature sensor close to the resistor module.

The control module may be configured to acquire a temperature detection value of the temperature sensor, and generate a second switch control signal when the temperature detection value is greater than or equal to a preset second threshold. Additionally, or alternatively, the switch module may be configured to disconnect the energy release circuit on the basis of the second switch control signal.

The temperature sensor may be being configured to generate a third switch control signal when a temperature detection value is greater than or equal to a preset second threshold; and/or the switch module may be configured to disconnect the energy release circuit on the basis of the third switch control signal.

Thus, in one or more exemplary embodiments of the present disclosure, a temperature sensor may be arranged close to the resistor module, and when the temperature of the resistor module is too high, the energy release circuit can be disconnected automatically to protect the resistor module and increase safety.

The brake chopper may further include a switch driving module, arranged between the control module and the switch module, and configured to drive the switch module on the basis of the first switch control signal, the second switch control signal and/or the third switch control signal.

As can be seen, driving of the switch module with multiple types of signals is realized on the basis of the switch driving module.

In an embodiment, the control module may be configured to determine a connection state of the resistor module on the basis of a second difference between a low-side potential value of the resistor module and the voltage value of the DC bus when the energy release circuit is in a disconnected state.

Thus, in embodiments of the present disclosure, a self-check function for the resistor module is realized through the difference between the low-side potential value of the resistor module and the voltage value of the DC bus.

In an embodiment, the switch module may comprise a first MOSFET (metal-oxide semiconductor field-effect transistor) and a second MOSFET.

The drain of the first MOSFET may be connected to the resistor module, the source of the first MOSFET may be connected to the drain of the second MOSFET, and the gate of the first MOSFET may be connected to the control module; the gate of the second MOSFET may be connected to the control module, and the source of the second MOSFET may be grounded; the first switch control signal may be adapted to keep the second MOSFET switched ON continuously, and to switch the first MOSFET ON for the duration of the ON time.

Thus, multiple switch protection may be achieved through multiple field effect transistor stages, increasing safety.

A control board may comprise:
a substrate;
a DC bus arranged on the substrate;
a resistor module, arranged on the substrate and electrically connected to the DC bus to form an energy release circuit of the DC bus;
a motor driving module, arranged on the substrate and configured to drive an electric motor on the basis of the DC bus;
a control module, arranged on the substrate and configured to control the motor driving module, determine the difference between a voltage value of the DC bus and a preset first threshold, and generate a first switch control signal on the basis of the difference; and
a switch module, arranged on the substrate and configured to control the ON time of the energy release circuit on the basis of the first switch control signal, wherein there may be a progressively increasing relationship between the ON time and the difference.

Thus, by integrating a brake chopper in a control board, an onboard brake chopper is realized, which can reduce the installation space and assembly cost of the brake chopper.

In an embodiment, the switch module may comprise a first MOSFET and a second MOSFET.

The drain of the first MOSFET may be connected to the resistor module, the source of the first MOSFET may be connected to the drain of the second MOSFET, and the gate of the first MOSFET may be connected to the control module; the gate of the second MOSFET may be connected to the control module, and the source of the second MOSFET may be grounded.

The first switch control signal may be adapted to keep the second MOSFET switched ON continuously, and to switch the first MOSFET ON for the duration of the ON time.

Thus, multiple switch protection may be achieved through multiple field effect transistor stages, increasing safety.

In an embodiment, a heat dissipating layer may be included, arranged at the bottom of the substrate, and configured to dissipate heat from the DC bus, the resistor module, the motor driving module, the control module and the switch module.

Thus, sharing the heat dissipating layer of the control board obviates the need to provide an additional heat dissipating device for the brake chopper, so costs are reduced and the degree of integration of the control board is increased.

A bus voltage control method may comprise:
determining a voltage value of a DC bus;
determining the difference between the voltage value of the DC bus and a preset first threshold;
generating a first switch control signal on the basis of the difference; and
controlling the ON time of an energy release circuit on the basis of the first switch control signal, wherein there may be a progressively increasing relationship between the ON time and the difference.

As can be seen, in embodiments of the present disclosure, the difference between the DC bus voltage value and a preset threshold may be used to precisely control the ON time of the energy release circuit, wherein there may be a progressively increasing relationship between the ON time and the difference. Thus, the greater the difference (and correspondingly, the greater the DC bus voltage value), the longer the ON time, so as to ensure full release of energy; the smaller the difference (and correspondingly, the smaller the DC bus voltage value), the shorter the ON time, to prevent excessive release of energy. Thus, in embodiments of the present disclosure, the ON time can be controlled adaptively on the basis of the DC bus voltage value, increasing the energy utilization rate of the DC bus.

The method may include:
acquiring a temperature detection value from a temperature sensor close to the resistor module;
when the temperature detection value may be greater than or equal to a preset second threshold, generating a second switch control signal; and
disconnecting the energy release circuit on the basis of the second switch control signal.

Thus, in embodiments of the present disclosure, a temperature sensor may be arranged close to the resistor module, and when the temperature of the resistor module is too high, the energy release circuit can be disconnected automatically to protect the resistor module and increase safety.

In an embodiment, the step of generating a first switch control signal on the basis of the difference may comprise: generating a PWM signal on the basis of the difference, the PWM signal having a duty cycle which has a progressively increasing relationship with the difference.

Thus, the ON time can be controlled flexibly on the basis of the duty cycle setting of the PWM signal.

The method may include:
acquiring a low-side potential value of the resistor module when the energy release circuit is in a disconnected state; and
determining a connection state of the resistor module on the basis of the difference between the low-side potential value of the resistor module and the voltage value of the DC bus; wherein, when the second difference is zero, the connection state of the resistor module may be determined to be compliant, and when the second difference is not zero, the connection state of the resistor module may be determined to be non-compliant.

Thus, in embodiments of the present disclosure, a self-check function for the resistor module may be realized through the difference between the low-side potential value of the resistor module and the voltage value of the DC bus.

An electronic device may comprise:
a processor; and
a memory for storing an executable instruction of the processor.

The processor may be configured to read the executable instruction from the memory and execute the executable instruction to implement a bus voltage control method according to one or more exemplary embodiments of the disclosure.

A computer-readable storage medium on which a computer instruction is stored, wherein the bus voltage control method described above is implemented when the computer instruction is executed by a processor.

In a variable-frequency speed regulating system, a given frequency of the electric motor may be gradually reduced to reduce the speed of the electric motor. However, when the inertia of the electric motor traction system is high, the actual speed of the electric motor is higher than its synchronous speed; the rotor windings of the electric motor cut the lines of magnetic force of the rotating magnetic field in the opposite direction to that during constant-speed operation of the electric motor, and the induced emf in the rotor windings is opposite to the direction of current, so the electric motor experiences negative torque, with kinetic energy of the traction system being fed back to the DC bus of the frequency converter. This causes the DC bus voltage to rise continuously, possibly damaging the frequency converter. If the kinetic energy fed back by the traction system is dissipated as heat using a brake chopper, the DC bus voltage can be kept stable.

The applicant has discovered that in a brake chopper in the prior art, a fixed switch control signal is used to control the ON time of an energy release circuit. However, the voltage value of the DC bus is generally variable; with the fixed switch control signal, it is difficult to adapt to voltage value changes, making it difficult to ensure the energy utilization rate of the DC bus. Furthermore, brake choppers in the prior art are widely implemented as independent products positioned externally on an electric motor control board, and require a large amount of space for installation, as well as having high assembly costs. In addition, brake choppers in the prior art typically lack switch protection and resistor overheating protection. Brake choppers in the prior art also typically lack a self-check function for the resistor.

In embodiments of the present disclosure, the difference between the DC bus voltage value and a preset threshold may be used to precisely control the ON time of the energy release circuit, thereby increasing the energy utilization rate of the DC bus. In addition, in embodiments of the present disclosure, the brake chopper may be integrated in the control board; the onboard brake chopper can reduce installation space and assembly costs, as well as cooling costs. Furthermore, a temperature sensor may be arranged close to the resistor module; when the temperature of the resistor module is too high, the energy release circuit can be disconnected automatically to increase the safety of the resistor module. Moreover, in embodiments of the present disclosure, multiple switch protection may be achieved through multiple field effect transistor stages, thus increasing switch safety. In addition, in embodiments of the present disclosure, a resistor self-check function may also be realized by comparing a resistor low-side potential value with a DC bus voltage value.

The disclosure above has provided a detailed explanation of the technical deficiencies in the prior art, the reasons for these technical deficiencies, and the thought and analysis processes for overcoming them. In fact, the recognition of the abovementioned technical deficiencies is not common knowledge in the art, but rather is an original discovery made by the applicant in the course of research. In addition, the tracing of the reasons for these technical deficiencies and the thought and analysis processes for overcoming them are the results of gradual analysis achieved by the applicant in the course of actual research, and not common knowledge in the art.

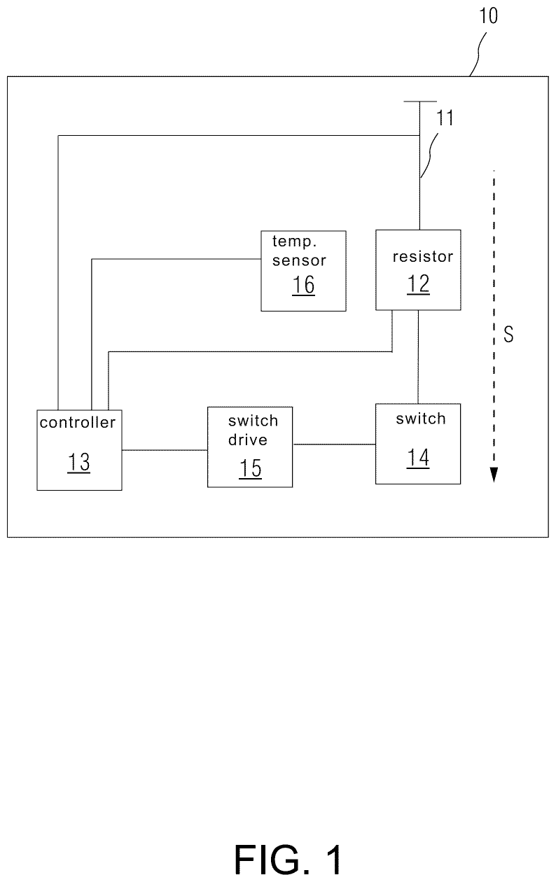

FIG. 1 is a demonstrative structural drawing of a brake chopper according to embodiments of the present disclosure. As shown in FIG. 1, the brake chopper 10 may comprise:

a resistor module 12, electrically connected to a DC bus 11 to form an energy release circuit of the DC bus 11; a control module 13, for determining the difference between a voltage value of the DC bus 11 and a preset first threshold, and generating a first switch control signal on the basis of the difference; and a switch module 14, for controlling the ON time of the energy release circuit on the basis of the first switch control signal, wherein there may be a progressively increasing relationship between the ON time and the difference. The progressively increasing relationship between the ON time and the difference may be a linear progressively increasing relationship or a non-linear progressively increasing relationship. For example, if the progressively increasing relationship may be a linear progressively increasing relationship, the ON time increases linearly as the difference increases; if the progressively increasing relationship may be a non-linear progressively increasing relationship, the ON time increases non-linearly as the difference increases.

In an embodiment, the resistor module 12 may be implemented as multiple resistors of lower resistance, connected in parallel with each other; or may be implemented as one or more resistors of higher resistance, connected in series with each other; or may be implemented as a hybrid connected structure comprising one or more parallel-connected resistors and one or more series-connected resistors. The DC bus 11 and the resistor module 12 are electrically connected to form the energy release circuit of the DC bus 11 (as shown by the arrow S in FIG. 1). The switch module 14 may be arranged in the energy release circuit, and configured to switch the energy release circuit of the DC bus 11 ON or OFF.

The first threshold may be set in the control module 13. The value of the first threshold may be fixed or adjustable. Preferably, the value of the first threshold may be adjustable. The control module 13 detects the voltage value of the DC bus 11, calculates the difference between the voltage value of the DC bus 11 and the first threshold, and generates the first switch control signal on the basis of the difference. The first switch control signal generated by the control module 13 may be adapted to control the switch module 14 and thereby control the ON time of the energy release circuit, wherein there may be a progressively increasing relationship between the ON time represented by the first switch control signal and the difference. Thus, in embodiments of the present disclosure, the difference between the DC bus voltage value and the first threshold may be used to precisely control the ON time of the energy release circuit. The greater the difference (and correspondingly, the greater the DC bus voltage value), the longer the ON time of the energy release circuit, so as to ensure full release of energy; the smaller the difference (and correspondingly, the smaller the DC bus voltage value), the shorter the ON time of the energy release circuit, to prevent excessive release of energy. In embodiments of the present disclosure, the ON time of the energy release circuit can be controlled adaptively on the basis of the DC bus voltage value, to increase the energy utilization rate of the DC bus.

In an embodiment, the brake chopper 10 may comprise: a temperature sensor 16 close to the resistor module 12; the control module 13, for acquiring a temperature detection value of the temperature sensor 16, and generating a second switch control signal when the temperature detection value may be greater than or equal to a preset second threshold; and the switch module 14, for disconnecting the energy release circuit on the basis of the second switch control signal.

Thus, in embodiments of the present disclosure, the temperature sensor 16 may be arranged close to the resistor module 12, and when the temperature of the resistor module 12 may be too high, the control module 13 generates the second switch control signal adapted to disconnect the energy release circuit, and the switch module 14 then disconnects the energy release circuit on the basis of the second switch control signal, thereby protecting the resistor module 12 and increasing safety. In this embodiment, the control module 13 generates the control signal for disconnecting the energy release circuit, so the control capability of the control module 13 may be increased.

In an embodiment, the brake chopper 10 may comprise: the temperature sensor 16 close to the resistor module 12, the temperature sensor 16 being configured to generate a third switch control signal when the temperature detection value may be greater than or equal to the preset second threshold; and the switch module 14, for disconnecting the energy release circuit on the basis of the third switch control signal.

Thus, in embodiments of the present disclosure, the temperature sensor 16 may be arranged close to the resistor module 12, and when the temperature of the resistor module 12 may be too high, the temperature sensor 16 generates the third switch control signal adapted to disconnect the energy release circuit, and the switch module 14 then disconnects the energy release circuit on the basis of the third switch control signal, thereby protecting the resistor module 12 and increasing safety. In this embodiment, the temperature sensor 16 may be used to generate the control signal for disconnecting the energy release circuit, so the response time may be reduced and the circuit disconnection efficiency is increased.

In an embodiment, the brake chopper 10 may comprise: a switch driving module 15, arranged between the control module 13 and the switch module 14, and configured to drive the switch module 14 on the basis of the first switch control signal, the second switch control signal and/or the third switch control signal. For example, the switch driving module 15 may amplify the power of the first switch control signal, the second switch control signal and/or the third switch control signal, so that it is sufficient to drive the switch module 14.

In an embodiment, the control module 13 may be configured to determine a connection state of the resistor module 12 on the basis of a second difference between a low-side potential value of the resistor module 12 and the voltage value of the DC bus 11 when the energy release circuit is in a disconnected state. When the second difference is zero (i.e. the low-side potential value of the resistor module 12 and the voltage value of the DC bus 11 are the same), the connection state of the resistor module 12 is determined to be compliant; when the second difference is not zero (i.e. the low-side potential value of the resistor module 12 and the voltage value of the DC bus 11 are not the same), the connection state of the resistor module 12 is determined to be non-compliant.

For example, when the brake chopper is activated, the energy release circuit is in a disconnected state; at this time, the connection state of the resistor module 12 is determined on the basis of the second difference between the low-side potential value of the resistor module 12 and the voltage value of the DC bus 11. Thus, in embodiments of the present disclosure, a self-check function for the resistor module 12 may be realized through the difference between the low-side potential value of the resistor module 12 and the voltage value of the DC bus 11.

In an embodiment, the switch module 14 may comprise a first MOSFET and a second MOSFET; the drain of the first MOSFET may be connected to the resistor module 12, the source of the first MOSFET may be connected to the drain of the second MOSFET, and the gate of the first MOSFET may be connected to the control module 13; the gate of the second MOSFET may be connected to the control module 13, and the source of the second MOSFET may be grounded; the first switch control signal may be adapted to keep the second MOSFET switched ON continuously, and to switch the first MOSFET ON for the duration of the ON time. For example, the first MOSFET and the second MOSFET may be implemented as N-type MOSFETs. Thus, multiple switch protection may be achieved through multiple field effect transistor stages, increasing safety.

A typical structure of the switch module 14 has been described demonstratively above, taking two MOSFETs as an example. Those skilled in the art will realize that such a description is merely demonstrative, and not intended to limit the scope of protection of embodiments of the present disclosure. For example, the switch module 14 could also be implemented as a junction field effect transistor (junction FET, JFET), or comprise a greater number of MOSFETs, or use a P-type MOSFET, etc.; the embodiments of the present disclosure impose no limitations in this respect.

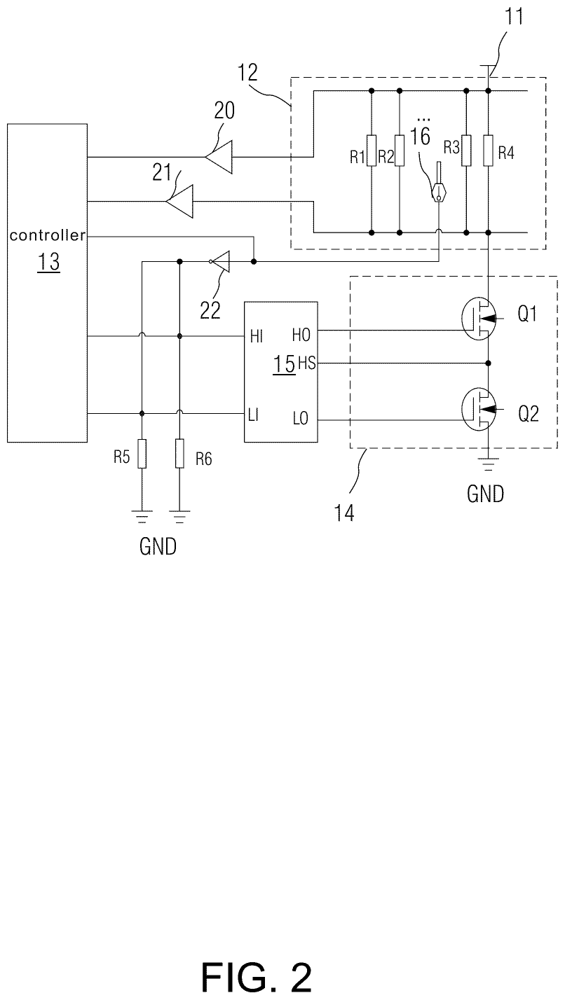

A demonstrative circuit structure of the brake chopper in embodiments of the present disclosure is described in specific terms below. FIG. 2 is a demonstrative circuit diagram of a brake chopper according to embodiments of the present disclosure.

In FIG. 2, the resistor module 12 may comprise multiple power resistors R1-R4, connected in parallel with each other. The high side of the resistor module 12 may be connected to the DC bus 11 (for example, the nominal voltage of the DC bus 11 may be 48 volts). The high side of the resistor module 12 may be also connected to the control module 13 via a high-impedance operational amplifier 20. The low side of the resistor module 12 may be connected to the switch module 14. The low side of the resistor module 12 may be also connected to the control module 13 via a high-impedance operational amplifier 21. The switch module 14 may be grounded (GND). The DC bus 11 and the resistor module 12 form the energy release circuit of the DC bus 11. The switch module 14 may be arranged in the energy release circuit, and configured to switch the energy release circuit of the DC bus 11 ON or OFF.

When the brake chopper may be activated, the energy release circuit may be in a disconnected state. At this time, the control module 13 acquires the low-side potential value of the resistor module 12 via the high-impedance operational amplifier 21. In addition, the control module 13 acquires the voltage value of the DC bus 11 via the high-impedance operational amplifier 20. The control module 13 determines the connection state of the resistor module 12 on the basis of the difference between the low-side potential value of the resistor module and the voltage value of the DC bus 11. When the difference is zero (i.e. the low-side potential value and the voltage value of the DC bus 11 are both 48 volts), the connection state of the resistor module 12 is determined to be compliant; when the difference is not zero, the connection state of the resistor module 12 is determined to be non-compliant. Thus, in embodiments of the present disclosure, a self-check function for the resistor module 12 may be realized through the difference between the low-side potential value of the resistor module 12 and the voltage value of the DC bus 11.

The first threshold may be set in the control module 13. The first threshold may be generally larger than the voltage value of the DC bus 11; for example, the first threshold may be set at 60 volts. The control module 13 acquires the voltage value of the DC bus 11 via the high-impedance operational amplifier 20. The control module 13 determines the difference between the voltage value of the DC bus and the first threshold, and on the basis of the difference, generates the first switch control signal adapted to control the ON time of the switch module 14, wherein there may be a progressively increasing relationship between the ON time and the difference. The switch module 14 controls the ON time of the energy release circuit on the basis of the first switch control signal.

The temperature sensor 16 may be close to the resistor module 12. The temperature sensor 16 continuously collects temperature detection values of the surrounding environment of the resistor module 12. The temperature sensor 16 can send the collected temperature detection values to the control module 13.

In an embodiment, the second threshold may be set in the control module 13. The second threshold may be fixed or adjustable. Preferably, the value of the second threshold may be adjustable. When the control module 13 determines that the temperature detection value may be greater than or equal to the second threshold, the control module 13 generates the second switch control signal, which may be adapted to disconnect the energy release circuit. Optionally, the second threshold may be set in the temperature sensor 16. When the temperature sensor 16 determines that the temperature detection value may be greater than or equal to the preset second threshold, the temperature sensor 16 generates the third switch control signal, which may be adapted to disconnect the energy release circuit.

Compared with the case where the control module 13 generates the second switch control signal, having the temperature sensor 16 generate the third switch control signal allows the disconnection of the energy release circuit to be controlled directly, reducing the response time and increasing the circuit disconnection efficiency, and also reducing the processing strain on the control module 13.

The switch driving module 15 may be arranged between the control module 13 and the switch module 14. An input end of the switch driving module 15 may comprise an HI terminal and an LI terminal. An output end of the switch driving module 15 may comprise an HO terminal and an LO terminal. The switch driving module 15 receives the first switch control signal or the second switch control signal from the control module 13 via the HI terminal and the LI terminal, or receives the third switch control signal from the temperature sensor 16 via the HI terminal and the LI terminal. The switch driving module 15 subjects the first switch control signal, the second switch control signal or the third switch control signal to power amplification, so as to drive the switch module 14.

The temperature sensor 16 may be connected to an inverter 22. The output of the inverter 22 may be connected to the HI terminal and the LI terminal. The inverter 22 may be grounded via grounding resistors R5 and R6. For example, the inverter 22 inverts the HIGH third switch control signal generated by the temperature sensor 16 to a LOW signal, so that the switch driving module 15 can drive the switch module 14 to disconnect the energy release circuit on the basis of the LOW third switch control signal.

The switch module 14 may comprise the first MOSFET (Q1) and the second MOSFET (Q2). The first MOSFET (Q1) and the second MOSFET (Q2) are both N-type. The drain of the first MOSFET (Q1) may be connected to the resistor module 12, the source of the first MOSFET (Q1) may be connected to the drain of the second MOSFET (Q2), and the gate of the first MOSFET (Q1) may be connected to the HO terminal of the switch driving module 15. The gate of the second MOSFET (Q2) may be connected to the LO terminal of the switch driving module 15, and the source of the second MOSFET (Q2) may be grounded (GND). A bootstrap terminal (HS) in the switch driving module 15 may be further connected at the point of connection between the source of the first MOSFET and the drain of the second MOSFET (Q2). The switch driving module 15 provides a bootstrap signal for the switch module 14 via the bootstrap terminal (HS), so that an output signal of the switch module 14 may be sufficient to offset the effect of a feedback signal.

When the input of the HI terminal is HIGH, the output of the HO terminal is HIGH, and the first MOSFET (Q1) is ON. When the input of the HI terminal is LOW, the output of the HO terminal is LOW, and the first MOSFET (Q1) is OFF. When the input of the LI terminal is HIGH, the output of the LO terminal is HIGH, and the second MOSFET (Q2) is ON. When the input of the LI terminal is LOW, the output of the LO terminal is LOW, and the second MOSFET (Q2) is OFF.

The first switch control signal may be adapted to keep the second MOSFET (Q2) switched ON continuously, and to switch the first MOSFET (Q1) ON for the duration of the ON time. For example, the first switch control signal may comprise a HIGH HI signal (preferably a PWM signal with a duty cycle that has a progressively increasing relationship with the difference) and a HIGH LI signal (preferably a continuously HIGH signal, e.g. a PWM signal with a duty cycle of 100%). The switch driving module 15 subjects the first switch control signal to power amplification, and outputs a HIGH HO signal (preferably a PWM signal with the same duty cycle as the LI signal) and a HIGH LO signal (preferably a continuously HIGH signal, e.g. a PWM signal with a duty cycle of 100%). At this time, the first MOSFET (Q1) is ON for the duration of the ON time represented by the duty cycle of the HO signal and otherwise OFF, and the second MOSFET (Q2) is continuously ON.

The second switch control signal may be adapted to switch the first MOSFET (Q1) and the second MOSFET (Q2) OFF. For example, the second switch control signal may comprise a LOW HI signal and a LOW LI signal, and the switch driving module 15 outputs a LOW HO signal and a LOW LO signal. At this time, the first MOSFET (Q1) and the second MOSFET (Q2) are both OFF.

The third switch control signal may be adapted to switch the first MOSFET (Q1) and the second MOSFET (Q2) OFF.

For example, the third switch control signal may comprise a LOW HI signal and a LOW LI signal, and the switch driving module 15 outputs a LOW HO signal and a LOW LO signal. At this time, the first MOSFET (Q1) and the second MOSFET (Q2) are both OFF. Below, Table 1 shows a truth table for the HI signal, the LI signal, the HI signal and the HO signal. X means no signal.

TABLE 1

| HI | LI | HO | LO |
|---|---|---|---|
| 0 | 0 | 0 | 0 |
| 0 | 1 | 0 | 1 |
| 1 | 0 | 1 | 0 |
| 1 | 1 | 1 | 1 |
| X | X | 0 | 0 |

When the HI signal has an input, the HO signal and the HI signal have the same state; when the LI signal has an input, the LO signal and the LI signal have the same state. When the HI signal has no input, the HO signal output is LOW; when the HI signal has no input, the LO signal output is LOW.

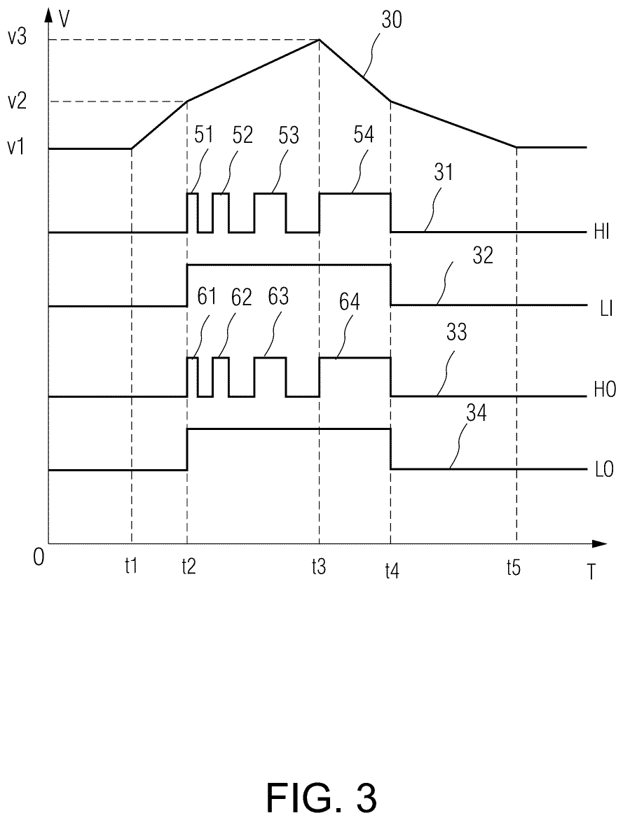

FIG. 3 is a demonstrative schematic diagram showing the correspondence between the bus voltage and the switch control signal according to embodiments of the present disclosure. In the coordinate system shown in FIG. 3, the horizontal coordinates are time (T) and the vertical coordinates are voltage (V). Assume that the nominal voltage (v1) of the DC bus may be 48 volts, the first threshold (v2) may be 60 volts, and the maximum voltage (v3) of the DC bus may be 70 volts. It can be seen from the DC bus voltage curve 30 that the DC bus voltage may vary.

(1): When the DC bus voltage is the nominal voltage (v1) (corresponding to interval 0-t1 on the horizontal axis), the HI signal curve 31 and the LI signal curve 32 are both LOW. Correspondingly, the HO signal curve 33 and the LO signal curve are LOW. Thus, the first MOSFET (Q1) and the second MOSFET (Q2) are both OFF, and the energy release circuit is disconnected.

(2): When the DC bus voltage is greater than the nominal voltage (v1) and less than the first threshold (v2) (corresponding to interval t1-t2 on the horizontal axis), the HI signal curve 31 and the LI signal curve 32 are both LOW. Correspondingly, the HO signal curve 33 and the LO signal curve are LOW. Thus, the first MOSFET (Q1) and the second MOSFET (Q2) are both OFF, and the energy release circuit is disconnected.

(3): When the DC bus voltage is greater than the first threshold (v2) and less than the maximum voltage (corresponding to interval t2-t3 on the horizontal axis), the LI signal curve 32 and the LO signal curve 34 are continuously HIGH, so the second MOSFET (Q2) is continuously ON. The HI signal curve 31 may comprise a first waveform 51, a second waveform 52, a third waveform 53 and a fourth waveform 54. As the DC bus voltage gradually increases, the fourth waveform 54 has a larger duty cycle than the third waveform 53, the third waveform 53 has a larger duty cycle than the second waveform 52, and the second waveform 52 has a larger duty cycle than the first waveform 51. The HO signal curve 33 may comprise a fifth waveform 61, a sixth waveform 62, a seventh waveform 63 and an eighth waveform 64. As the DC bus voltage gradually increases, the eighth waveform 64 has a larger duty cycle than the seventh waveform 63, the seventh waveform 63 has a larger duty cycle than the sixth waveform 62, and the sixth waveform 62 has a larger duty cycle than the fifth waveform 61. Thus, the second MOSFET (Q2) is continuously ON, whereas the first MOSFET (Q1) is ON when the HO signal is HIGH, and OFF when the HO signal is LOW.

(4): When the DC bus begins to fall from the maximum voltage and the DC bus voltage value is still greater than the first threshold (v2) (corresponding to interval t3-t4 on the horizontal axis), the HI signal curve 31, the LI signal curve 32, the HO signal curve 33 and the LO signal curve 34 are continuously HIGH, so the first MOSFET (Q1) and the second MOSFET (Q2) are continuously ON, and the energy release circuit is continuously ON.

(5): When the DC bus voltage value falls to below the first threshold (v2) (corresponding to interval t4-t5 on the horizontal axis), the HI signal curve 31, the LI signal curve 32, the HO signal curve 33 and the LO signal curve 34 are continuously LOW, so the first MOSFET (Q1) and the second MOSFET (Q2) are continuously OFF, and the energy release circuit is continuously OFF.

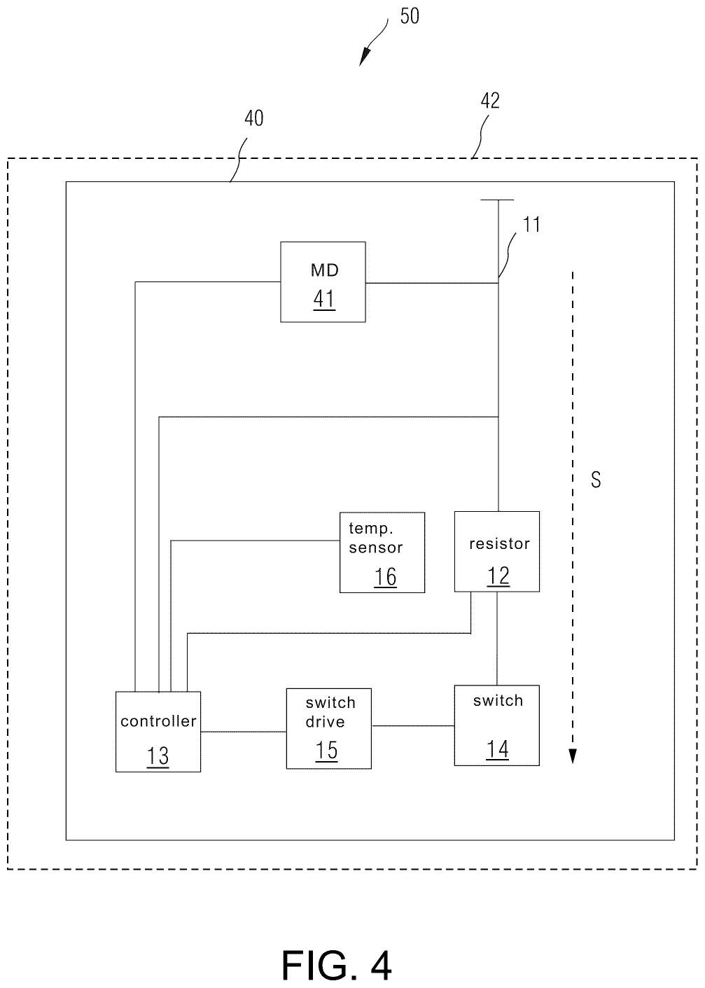

Embodiments of the present disclosure also propose a control board. For example, the control board may be implemented as a motor control board for controlling an electric motor. FIG. 4 is a demonstrative structural drawing of a control board according to embodiments of the present disclosure.

The control board 50 may comprise: a substrate 40; a DC bus 11, arranged on the substrate 40; a resistor module 12, arranged on the substrate 40 and electrically connected to the DC bus 11 to form an energy release circuit of the DC bus 11; a motor driving module 41, arranged on the substrate 40 and configured to drive an electric motor on the basis of the DC bus 11; a control module 13, arranged on the substrate 40 and configured to control the motor driving module 41, determine the difference between a voltage value of the DC bus 11 and a preset first threshold, and generate a first switch control signal on the basis of the difference; and a switch module 14, arranged on the substrate 40 and configured to control the ON time of the energy release circuit on the basis of the first switch control signal, wherein there may be a progressively increasing relationship between the ON time and the difference.

In an embodiment, the control board 50 may be implemented as a rigid circuit board or a flexible circuit board. When the control board 50 is implemented as a rigid circuit board, the substrate 40 may comprise a phenolic paper layer, an epoxy paper layer, a polyester glass mat layer or an epoxy glass cloth layer, etc. When the control board 50 is implemented as a flexible circuit board, the substrate 40 may comprise a polyester thin film or a polyimide thin film, etc.

Thus, by integrating a brake chopper in a control board, an onboard brake chopper is realized, which can reduce the installation space and assembly cost of the brake chopper.

In an embodiment, the switch module 14 may comprise a first MOSFET and a second MOSFET; the drain of the first MOSFET may be connected to the resistor module 12, the source of the first MOSFET may be connected to the drain of the second MOSFET, and the gate of the first MOSFET may be connected to the control module 13; the gate of the second MOSFET may be connected to the control module 13, and the source of the second MOSFET may be grounded; the first switch control signal may be adapted to keep the second MOSFET switched ON continuously, and to switch the first MOSFET ON for the duration of the ON time.

In an embodiment, the control board 50 may comprise a heat dissipating layer 42, arranged at the bottom of the substrate 40, and configured to dissipate heat from the DC bus 11, the resistor module 12, the motor driving module 41, the control module 13 and the switch module 14.

Thus, sharing the heat dissipating layer of the control board obviates the need to provide an additional heat dissipating device for the brake chopper, so costs are reduced and the degree of integration of the control board is increased.

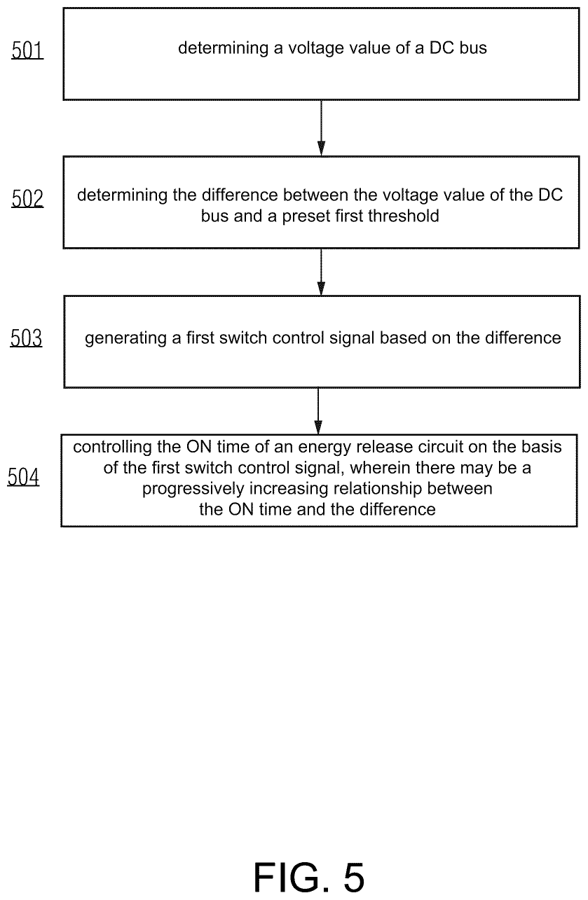

Embodiments of the present disclosure also propose a bus voltage control method. FIG. 5 is a demonstrative flow chart of a bus voltage control method according to embodiments of the present disclosure. As FIG. 5 shows, the method may comprise:

Step 501: determining a voltage value of a DC bus.

Step 502: determining the difference between the voltage value of the DC bus and a preset first threshold.

Step 503: generating a first switch control signal on the basis of the difference.

Step 504: controlling the ON time of an energy release circuit on the basis of the first switch control signal, wherein there may be a progressively increasing relationship between the ON time and the difference.

In an embodiment, the method may comprise: acquiring a temperature detection value from a temperature sensor close to the resistor module; when the temperature detection value may be greater than or equal to a preset second threshold, generating a second switch control signal; disconnecting the energy release circuit on the basis of the second switch control signal.

In an embodiment, step 503 specifically may comprise: generating a PWM signal on the basis of the difference, the PWM signal having a duty cycle which has a progressively increasing relationship with the difference.

In an embodiment, the method may comprise: acquiring a low-side potential value of the resistor module when the energy release circuit is in a disconnected state; determining a connection state of the resistor module on the basis of the difference between the low-side potential value of the resistor module and the voltage value of the DC bus; wherein, when the second difference is zero, the connection state of the resistor module is determined to be compliant, and when the second difference is not zero, the connection state of the resistor module is determined to be non-compliant.

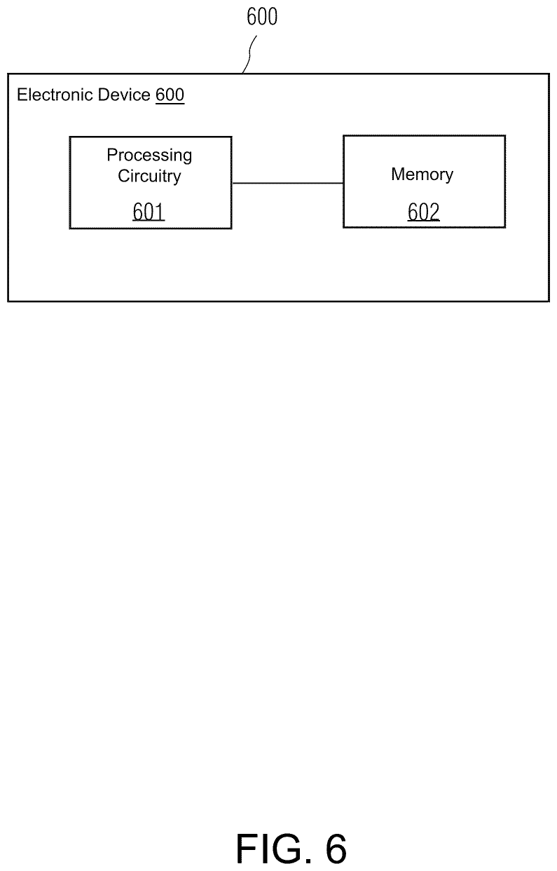

Embodiments of the present disclosure further propose an electronic device with a processor-memory architecture. FIG. 6 is a structural drawing of an electronic device according to embodiments of the present disclosure. As shown in FIG. 6, the electronic device 600 may comprise processing circuitry (e.g., one or more processors) 601, a memory 602, and a computer program stored on the memory 602 and executable on the processor 601, wherein any one of the bus voltage control methods above may be implemented when the computer program is executed by the processor 601. The memory 602 may specifically be implemented as various types of storage media, such as an electrically erasable programmable read-only memory (EEPROM), a flash memory or a programmable read-only memory (PROM). The processor 601 may be implemented as comprising one or more central processors or one or more field-programmable gate arrays, wherein the field-programmable gate array integrates one or more central processor cores. Specifically, the central processor or central processor core can be implemented as a CPU, MCU or DSP, etc.

It must be explained that not all of the steps and modules in the flows and structural diagrams above are necessary; certain steps or modules may be omitted according to actual requirements. The sequence in which the steps are executed is not fixed, and may be adjusted as needed. The partitioning of the modules is merely functional partitioning, employed for the purpose of facilitating description; during actual implementation, one module may be realized by multiple modules, and the functions of multiple modules may be realized by the same module; these modules may be located in the same device, or in different devices.

Hardware modules in the embodiments may be realized mechanically or electronically. For example, one hardware module may comprise a specially designed permanent circuit or logic device (such as a dedicated processor, such as an FPGA or ASIC) for completing a specific operation. The hardware module may also comprise a programmable logic device or circuit that may be temporarily configured by software (e.g. comprising a general processor or another programmable processor) for executing a specific operation. The choice of whether to specifically use a mechanical method, or a dedicated permanent circuit, or a temporarily configured circuit (e.g. configured by software) to realize the hardware module can be decided according to considerations of cost and time.

The embodiments above are merely preferred embodiments of the present disclosure, which are not intended to define the scope of protection of the present disclosure. Any amendments, equivalent substitutions or improvements etc. made within the spirit and principles of the present disclosure shall be included in the scope of protection thereof.

To enable those skilled in the art to better understand the solution of the present disclosure, the technical solution in the embodiments of the present disclosure is described clearly and completely below in conjunction with the drawings in the embodiments of the present disclosure. Obviously, the embodiments described are only some, not all, of the embodiments of the present disclosure. All other embodiments obtained by those skilled in the art on the basis of the embodiments in the present disclosure without any creative effort should fall within the scope of protection of the present disclosure.

It should be noted that the terms “first”, “second”, etc. in the description, claims and abovementioned drawings of the present disclosure are used to distinguish between similar objects, but not necessarily used to describe a specific order or sequence. It should be understood that data used in this way can be interchanged as appropriate so that the embodiments of the present disclosure described here can be implemented in an order other than those shown or described here. In addition, the terms “comprise” and “have” and any variants thereof are intended to cover non-exclusive inclusion. For example, a process, method, system, product or equipment comprising a series of steps or modules or units is not necessarily limited to those steps or modules or units which are clearly listed, but may comprise other steps or modules or units which are not clearly listed or are intrinsic to such processes, methods, products or equipment.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general-purpose computer.

The various components described herein may be referred to as “modules,” “units,” or “devices.” Such components may be implemented via any suitable combination of hardware and/or software components as applicable and/or known to achieve their intended respective functionality. This may include mechanical and/or electrical components, processors, processing circuitry, or other suitable hardware components, in addition to or instead of those discussed herein. Such components may be configured to operate independently, or configured to execute instructions or computer programs that are stored on a suitable computer-readable medium. Regardless of the particular implementation, such modules, units, or devices, as applicable and relevant, may alternatively be referred to herein as “circuitry,” “controllers,” “processors,” or “processing circuitry,” or alternatively as noted herein.

For the purposes of this discussion, the term “processing circuitry” shall be understood to be circuit(s) or processor(s), or a combination thereof. A circuit includes an analog circuit, a digital circuit, data processing circuit, other structural electronic hardware, or a combination thereof. A processor includes a microprocessor, a digital signal processor (DSP), central processor (CPU), application-specific instruction set processor (ASIP), graphics and/or image processor, multi-core processor, or other hardware processor. The processor may be “hard-coded” with instructions to perform corresponding function(s) according to aspects described herein. Alternatively, the processor may access an internal and/or external memory to retrieve instructions stored in the memory, which when executed by the processor, perform the corresponding function(s) associated with the processor, and/or one or more functions and/or operations related to the operation of a component having the processor included therein.

In one or more of the exemplary embodiments described herein, the memory is any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

### REFERENCE LIST

10 Brake chopper
11 DC bus
12 Resistor module
13 Control module
14 Switch module
15 Switch driving module
16 Temperature sensor
20-21 High-impedance operational amplifier
22 Inverter
R1-R4 Power resistor
R5-R6 Grounding resistor
Q1 First MOSFET
Q2 Second MOSFET
30 DC bus voltage curve
31 HI signal curve
32 LI signal curve
33 HO signal curve
34 LO signal curve
51 First waveform
52 Second waveform
53 Third waveform
54 Fourth waveform
61 Fifth waveform
62 Sixth waveform
63 Seventh waveform
64 Eighth waveform
40 Substrate
41 Motor driving module
42 Heat dissipating layer
50 Control board
501-504 Steps
600 Electronic device
600 Processor
602 Memory

1. A brake chopper, comprising:
a resistor electrically connected to a direct-current (DC) bus to form an energy release circuit of the DC bus;
a controller configured to determine a difference between a voltage value of the DC bus and a preset first threshold value, and generate a first switch control signal based on the determined difference between a voltage value of the DC bus and a preset first threshold value; and
a switch configured to control an ON time of the energy release circuit based on the first switch control signal, wherein there is a progressively increasing relationship between the ON time and the determined difference between a voltage value of the DC bus and a preset first threshold value.

2. The brake chopper as claimed in claim 1, comprising: a temperature sensor adjacent to the resistor, wherein:
the controller may be configured to acquire a temperature detection value of the temperature sensor, and generate a second switch control signal in response to the temperature detection value being greater than or equal to a preset second threshold value, and the switch may be configured to disconnect the energy release circuit based on the second switch control signal; or
the temperature sensor may be configured to generate a third switch control signal in response to a temperature detection value being greater than or equal to the preset second threshold value, and the switch may be configured to disconnect the energy release circuit based on the third switch control signal.

3. The brake chopper as claimed in claim 2, comprising: a switch driver, arranged between the controller and the switch, configured to drive the switch based on the first switch control signal, the second switch control signal, and/or the third switch control signal.

4. The brake chopper as claimed in claim 1, wherein the controller is configured to determine a connection state of the resistor based on a second difference between a low-side potential value of the resistor and the voltage value of the DC bus when the energy release circuit is in a disconnected state.

5. The brake chopper as claimed in claim 1, wherein:
the switch comprises a first metal-oxide semiconductor field-effect transistor (MOSFET) and a second MOSFET;
a drain of the first MOSFET is connected to the resistor, a source of the first MOSFET is connected to a drain of the second MOSFET, and a gate of the first MOSFET is connected to the controller, a gate of the second MOSFET is connected to the controller, and a source of the second MOSFET is grounded; and
the first switch control signal is adapted to keep the second MOSFET switched ON continuously, and to switch the first MOSFET ON for a duration of the ON time.

6. A control board, comprising:
a substrate;
a direct-current (DC) bus arranged on the substrate;
a resistor arranged on the substrate and electrically connected to the DC bus to form an energy release circuit of the DC bus;
a motor drive arranged on the substrate and configured to drive an electric motor based on the DC bus;
a controller arranged on the substrate and configured to control the motor drive, determine a difference between a voltage value of the DC bus and a preset first threshold value, and generate a first switch control signal based on the difference between a voltage value of the DC bus and a preset first threshold value; and
a switch arranged on the substrate and configured to control an ON time of the energy release circuit based on the first switch control signal, wherein there is a progressively increasing relationship between the ON time and the difference between a voltage value of the DC bus and a preset first threshold value.

7. The control board as claimed in claim 6, wherein:
the switch comprises a first metal-oxide semiconductor field-effect transistor (MOSFET) and a second MOSFET;
a drain of the first MOSFET is connected to the resistor, a source of the first MOSFET is connected to a drain of the second MOSFET, and a gate of the first MOSFET is connected to the controller, a gate of the second MOSFET is connected to the controller, and a source of the second MOSFET is grounded; and
the first switch control signal is adapted to keep the second MOSFET switched ON continuously, and to switch the first MOSFET ON for a duration of the ON time.

8. The control board as claimed in claim 6, comprising: a heat dissipating layer, arranged at a bottom of the substrate, and configured to dissipate heat from the DC bus, the resistor, the motor drive, the controller, and the switch.

9. A bus voltage control method, comprising:
determining a voltage value of a direct-current (DC) bus;
determining a difference between the voltage value of the DC bus and a preset first threshold value;
generating a first switch control signal based on the difference between the voltage value of the DC bus and a preset first threshold value; and
controlling an ON time of an energy release circuit based on the first switch control signal, wherein there is a progressively increasing relationship between the ON time and the difference.

10. The method as claimed in claim 9, comprising:
acquiring a temperature detection value from a temperature sensor adjacent to a resistor electrically connected to the DC bus;
in response to the temperature detection value being greater than or equal to a preset second threshold, generating a second switch control signal; and
disconnecting the energy release circuit based on the second switch control signal.

11. The method as claimed in claim 9, wherein generating the first switch control signal comprises: generating a pulse width modulation (PWM) signal based on the difference between the voltage value of the DC bus and a preset first threshold value, the PWM signal having a duty cycle which has a progressively increasing relationship with the difference between the voltage value of the DC bus and a preset first threshold value.

12. The method as claimed in claim 9, comprising:
acquiring a low-side potential value of a resistor electrically connected to the DC bus, in response to the energy release circuit being in a disconnected state; and
determining a connection state of the resistor based on a difference between the low-side potential value of the resistor and the voltage value of the DC bus, wherein:
in response to the difference between the low-side potential value of the resistor and the voltage value of the DC bus being zero, the connection state of the resistor being determined to be compliant, and in response to the difference between the low-side potential value of the resistor and the voltage value of the DC bus not being equal to zero, the connection state of the resistor being determined to be non-compliant.

13. A non-transitory computer-readable storage medium with an executable program stored thereon, that when executed, instructs a processor to perform the method of claim 9.

14. An electronic device, comprising:
one or more processors; and
a memory storing an executable instruction that, when executed by the one or more processors, configure the electronic device to perform the method of claim 9.
